(19) United States
(12) Patent Application Publication
(10) Pub. No.: US 2025/0027864 A1
(43) Pub. Date: Jan. 23, 2025

(54) MEASURING SPRAY DROPLET SIZES FROM VIBRATIONS INDUCED BY SPRAY DROPLET IMPACTS

(71) Applicant: The United States of America, as Represented by the Secretary of Agriculture, Washington, DC (US)

(72) Inventors: HONGYOUNG JEON, WOOSTER, OH (US); HEPING ZHU, WOOSTER, OH (US)

(21) Appl. No.: 18/355,050

(22) Filed: Jul. 19, 2023

(51) Int. Cl. G01N 15/02

(52) U.S. Cl. CPC G01N 15/02

(57) ABSTRACT

Method, apparatus, and computer program product are disclosed for predicting one or more spray droplet size statistics. In some embodiments, vibration induced by impacts of spray droplets on a substrate is sensed (e.g., by a flexible resistor connected in series with a precision resistor to form a voltage divider) to acquire vibration data in the time domain, wherein the spray droplets are emitted by a nozzle positioned a predetermined distance from the substrate; the vibration data in the time domain are transformed to power data in the frequency domain (e.g., by applying the Fast Fourier transform); a cumulative power magnitude is computed based on the frequency domain power data over the data acquisition frequency; and spray droplet size statistics are predicted based on the cumulative power magnitude at a predetermined frequency by applying a prediction model correlating cumulative power magnitude at the predetermined frequency and the spray droplet size statistics.

### BACKGROUND OF THE INVENTION

Disclosed are a method, apparatus, and computer program product for predicting one or more spray droplet size statistics such as Dᵥ₁₀, Dᵥ₅₀ and Dᵥ₉₀. In some embodiments, vibration induced by impacts of spray droplets on a substrate is sensed by a vibration sensor (e.g., a flexible resistor connected in series with a precision resistor to form a voltage divider) to acquire vibration data in the time domain, wherein the spray droplets are emitted by a nozzle positioned a predetermined distance from the substrate; the vibration data in the time domain are transformed to power data in the frequency domain (e.g., by applying the Fast Fourier transform); a cumulative power magnitude is computed based on the power data in the frequency domain over the data acquisition frequency; and one or more spray droplet size statistics are predicted based on the cumulative power magnitude at a predetermined frequency by applying a prediction model correlating cumulative power magnitude at the predetermined frequency and the one or more spray droplet size statistics.

Typically, pesticides are applied using hydraulic nozzles that discharge pressurized liquid in air to break up into finer droplets to enhance the deposition and coverage on intended targets. It is important to know the sizes of these droplets because droplet size will influence on pesticide driftability, on-target deposition and coverage, and soil losses (Cerruto, E., et al., Agronomy, 12 (7): 1677 (2022); Nuyttens, D., et al., Biosystems Engineering, 97 (3): 333-345 (2007); Salyani, M., Transactions of the ASAE, 31 (6): 1680-1684 (1988)).

In fact, spray droplet sizes are one of the most important factors to predict the outcomes of pesticide spray applications as they influence spray deposition and drift (off-target movement). Currently available instruments to measure spray droplet sizes are delicate instrument and use sophisticated technologies.

Common approaches to measuring spray droplet sizes discharged from nozzles in research typically include the use phase Doppler particle analysis, high-speed image analysis, or laser diffraction (Sijs, R., et al., AIP Advances, 11 (1): 015315 (2021)). The instruments that use these common approaches are typically quite expensive, and their use is limited to controlled laboratory conditions. Therefore, these conventional instruments require substantial capital investment to acquire (typically, $80,000 or more). Moreover, these instruments need to be used in controlled environments and cannot be used in outdoor conditions, which makes it difficult to understand drift, deposition, and ground runoff in relation to spray droplet sizes because spray droplet sizes change with weather conditions (Maciel, C. F. S., et al., Revista Ciencia Agronomica, 49 (3): 430-436 (2018). These limitations create barriers to use such instruments to analyze spray droplet sizes by a wide range of users.

Alternative techniques to measure spray droplet sizes have not been well investigated yet. A machine learning-based classification technique to predict volume median diameter (D_{V50}) using a piezoelectric sensor was studied by Gargari, H. P., et al., INMATEH-Agricultural Engineering, 59(3): 151-160 (2019). U.S. Pat. No. 7,278,294 discloses a system and method for determining atomization characteristics of spray liquids being emittied by a nozzle by sensing vibrations within the nozzle.

In this disclosure, we describe a method, apparatus, and computer program product for predicting one or more spray droplet size statistics by sensing vibration induced by impacts of spray droplets on a substrate using, for example, a flexible resistor (colloquially known as a “flex sensor”) connected in series with a precision resistor to form a voltage divider. By using only such low cost and readily available components, the illustrative systems described herein substantially reduces instrument cost (as compared to the above-mentioned common approaches). Moreover, because these components are not delicate, the illustrative systems described herein can be used in the field.

### SUMMARY OF THE INVENTION

Embodiments of the present disclosure include a method, apparatus, and computer program product for predicting one or more spray droplet size statistics. In some embodiments, vibration induced by impacts of spray droplets on a substrate is sensed by a vibration sensor (e.g., a flexible resistor connected in series with a precision resistor to form a voltage divider) to acquire vibration data in the time domain, wherein the spray droplets are emitted by a nozzle positioned a predetermined distance from the substrate; the vibration data in the time domain are transformed to power data in the frequency domain (e.g., by applying the Fast Fourier transform); a cumulative power magnitude is computed based on the power data in the frequency domain over the data acquisition frequency; and one or more spray droplet size statistics are predicted based on the cumulative power magnitude at a predetermined frequency by applying a prediction model correlating cumulative power magnitude at the predetermined frequency and the one or more spray droplet size statistics.

In some embodiments, a system predicts droplet size statistics by using a vibration sensor to sense vibration induced by impacts of spray droplets on a substrate. The system may, for example, include a flexible resistor (which is connected in series with a high-precision resistor to form a voltage divider), a high-speed data acquisition system (DAQ), and a computer system. While feeding a fixed and low voltage to the voltage divider, the DAQ continues acquiring voltage data at the output of the voltage divider (i.e., the midpoint between the two series-connected resistors). When spray droplets impact on the flexible resistor, the flexible resistor bends and vibrates due to the impacts, and the bending and vibration change the resistance value of the flexible resistor. These resistance changes result in voltage changes at the midpoint of the voltage divider. Therefore, vibration data from spray droplet impacts can be acquired by collecting voltage changes at high speed.

In an illustrative example, with a fixed and low current voltage supplied to the series-connected resistors during the impacts, the resistance changes of the flexible resistor altered the voltage at the output of voltage divider corresponding to the vibrations of the flexible resistor, and the DAQ acquired the digital signals through analog-to-digital conversion of the analog voltage data at the output of the voltage divider while a nozzle (e.g., a flat fan nozzle, in this illustrative example) discharged spray droplets a predetermined distance (e.g., approximately 305 mm in this illustrative example) above the flexible resistor. The vibration data in the time domain were converted to power data in the frequency domain through the Fast Fourier transform (FFT). In this illustrative example, a preferred vibration measurement condition was identified as 2 s and 1024 Hz, allowing less than 5% of variation between measurements. The linear regression model between power distributions of different flat fan nozzles and corresponding droplet size statistics (e.g., volumetric droplet diameters D_{V10}, D_{V50}, and D_{V90}) measured by a laser diffraction system showed a strong correlation with high coefficients of determination (R²>0.85). The model showed good prediction accuracy with an average absolute approximation error of 4.2%, 5.1%, and 7.5% for volumetric droplet diameters D_{V10}, D_{V50}, and D_{V90}, respectively. The system presented herein provides a rapid and cost effective method to assay spray droplet size statistics of crop protection product tank mixes compared to conventional techniques.

This summary is provided to introduce a selection of concepts in a simplified form that are further described below in the detailed description. This summary is not intended to identify key features of the claimed subject matter, nor is intended as an aid in determining the scope of the claimed invention.

### BRIEF DESCRIPTION OF THE SEVERAL VIEWS OF THE DRAWINGS

Embodiments will hereinafter be described in conjunction with the appended drawings, where like designations denote like elements.

FIG. 1 depicts an exemplary system for predicting one or more spray droplet size statistics, according to one or more embodiments.

FIG. 2 depicts an exemplary voltage divider circuit including a flexible resistor that may be utilized, according to one or more embodiments, within the system for predicting one or more spray droplet size statistics shown in FIG. 1.

FIG. 3 is a flow diagram of an illustrative method of predicting one or more spray droplet size statistics, according to one or more embodiments.

FIG. 4 is a block diagram illustrating a representation of an exemplary computer system for performing a computer-implemented method of predicting one or more spray droplet size statistics, according to one or more embodiment.

FIG. 5 is a flow diagram of illustrative data analysis steps that may be utilized for predicting spray droplet size statistics, according to one or more embodiments. In the left-section of FIG. 5, plot a) depicts vibration data output (i.e., voltage in the time domain). In the mid-section of FIG. 5, plot b) depicts data after application of the Fast Fourier transform (i.e., power magnitude in the frequency domain). In the right-section of FIG. 5, plot c) depicts normalized cumulative power in the frequency domain.

FIG. 6 depicts a plot of cumulative power magnitude in the frequency domain which may be utilized in frequency selection (e.g., 10 Hz in this illustrative example) for the prediction model, according to one or more embodiments.

FIG. 7 depicts a plot of droplet size in relation to cumulative power magnitude from spray vibration at the selected frequency (e.g., 10 Hz in this illustrative example) of volumetric droplet diameters D_{V10} (denoted by squares), D_{V50} (denoted by triangles), and D_{V90} (denoted by rhombuses), according to one or more embodiments. In FIG. 7, lines represent the linear regressions for the respective volume droplet diameters. Also in FIG. 7, illustrative prediction models (i.e., mathematical equations corresponding to the linear regressions for the respective volume droplet diameters) are shown, along with the coefficient of determination (R²) and the root mean square error (RSME).

FIGS. 8A, 8B, and 8C depict illustrative validation curves for predicted droplet sizes that were predicted using prediction models for volumetric droplet diameters D_{V10}, D_{V50}, and D_{V90}, respectively, according to one or more embodiments. FIG. 8A depicts a plot of predicted droplet size in relation to measured droplet size for volume droplet diameter D_{V10}. FIG. 8B depicts a plot of predicted droplet size in relation to measured droplet size for volume droplet diameter D_{V50}. FIG. 8C depicts a plot of predicted droplet size in relation to measured droplet size for volume droplet diameter D_{V90}.

### DETAILED DESCRIPTION

Embodiments of the present disclosure include a method, apparatus, and computer program product for predicting one or more spray droplet size statistics. In some embodiments, vibration induced by impacts of spray droplets on a substrate is sensed by a vibration sensor (e.g., a flexible resistor connected in series with a precision resistor to form a voltage divider) to acquire vibration data in the time domain, wherein the spray droplets are emitted by a nozzle positioned a predetermined distance from the substrate; the vibration data in the time domain are transformed to power data in the frequency domain (e.g., by applying the Fast Fourier transform); a cumulative power magnitude is computed based on the power data in the frequency domain over the data acquisition frequency; and one or more spray droplet size statistics are predicted based on the cumulative power magnitude at a predetermined frequency by applying a prediction model correlating cumulative power magnitude at the predetermined frequency and the one or more spray droplet size statistics.

In some embodiments, a system predicts droplet size statistics by using a vibration sensor to sense vibration induced by impacts of spray droplets on a substrate. The system may, for example, include a flexible resistor (which is connected in series with a high-precision resistor to form a voltage divider), a high-speed data acquisition system (DAQ), and a computer system. While feeding a fixed and low voltage to the voltage divider, the DAQ continues acquiring voltage data at the output of the voltage divider (i.e., the midpoint between the two series-connected resistors). When spray droplets impact on the flexible resistor, the flexible resistor bends and vibrates due to the impacts, and the bending and vibration changes the resistance value of the flexible resistor. These resistance changes result in voltage changes at the midpoint of the voltage divider. Therefore, vibration data from spray droplet impacts can be acquired by collecting voltage changes at high speed. Typically, vibration measurement conditions are up to about 2 s (e.g., 2 s) and up to about 1024 Hz (e.g., 1024 Hz). In the illustrative systems described herein, a preferred vibration measurement condition was identified as 2 s and 1024 Hz.

One skilled in the art will appreciate that other vibration sensors may be used in lieu of, or in addition to, the flexible resistor. Suitable examples of such alternative vibration sensors include, but are not limited to, an accelerometer and a cantilevered beam with a stain gauge.

One skilled in the art will also appreciate that a microcontroller may be used to provide data acquisition in lieu of a DAQ. Such a microcontroller would be configured to provide, at suitable measurement conditions, analog-to-digital conversion of the analog voltage signal from the output of the voltage divider to digital vibration data. As noted above, typical vibration measurement conditions are up to about 2 s (e.g., 2 s) and up to about 1024 Hz (e.g., 1024 Hz).

After the time domain data (i.e., vibration data) is acquired, the data is transformed to power data in the frequency domain by Fast Fourier transform (FFT). Then the power data in the frequency domain is normalized, and cumulative power is calculated. Then spray droplet size statistics (e.g., volumetric droplet diameters D_{V10}, D_{V50}, and D_{V90}) re predicted with cumulative normalized power at a certain frequency. As described below, this frequency may be selected when building the prediction model. Typically, the selected frequency is up to about 512 Hz (e.g., 512 Hz). In the illustrative systems described herein, the selected frequency is 10 Hz and we use a cumulative normalized power at 10 Hz to correlate with spray droplet size statistics.

In an illustrative example, with a fixed and low current voltage supplied to the series-connected resistors during the impacts, the resistance changes of the flexible resistor altered the voltage at the output of voltage divider corresponding to the vibrations of the flexible resistor, and the DAQ acquired the digital signals through analog-to-digital conversion of the analog voltage data at the output of the voltage divider while a nozzle (e.g., a flat fan nozzle, in this illustrative example) discharged spray droplets a predetermined distance (e.g., approximately 305 mm in this illustrative example) above the flexible resistor. The vibration data in the time domain were converted to power data in the frequency domain through the Fast Fourier transform (FFT). In this illustrative example, a preferred vibration measurement condition was identified as 2 s and 1024 Hz, allowing less than 5% of variation between measurements. The linear regression model between power distributions of different flat fan nozzles and corresponding droplet size statistics (e.g., volumetric droplet diameters D_{V10}, D_{V50}, and D_{V90}) measured by a laser diffraction system showed a strong correlation with high coefficients of determination (R²>0.85). The model showed good prediction accuracy with an average absolute approximation error of 4.2%, 5.1%, and 7.5% for volumetric droplet diameters D_{V10}, D_{V50}, and D_{V90}, respectively. The system presented herein provides a rapid and cost effective method to assay spray droplet size statistics of crop protection product tank mixes compared to conventional techniques.

In accordance with some embodiments, a lightweight substrate (e.g., a plant leaf) may be attached to the flexible resistor and the vibrations can still be measured. In addition, spray deposition on a substrate can be calculated using time domain data collected before and during the spray. Thus, measuring spray droplet sizes and deposition can be measured at the same time.

The illustrative systems described herein simplify the instrument for measuring spray droplet sizes and use only low cost and readily available components. As a result, instrument cost is reduced substantially (e.g., total cost of the illustrative systems is estimated to be $300-$400, excluding a computer). This contrasts with conventional instruments for measuring spray droplet size that typically cost $80,000 or more.

Moreover, the illustrative systems described herein can measure spray droplet sizes anywhere, so long as the environment does not contain low frequency and high magnitude vibrations. This contrasts with conventional instruments for measuring spray droplet size that use techniques such as phase Doppler particle analysis, high-speed image analysis, and laser diffraction. These techniques require a controlled environment (e.g., these instruments particularly require isolation from outdoor illumination).

An intangible benefit of the illustrative systems would be less crop injuries from spray off-target movement (drift) because the availability of the instrument measuring spray droplet sizes will greatly increase since the instrument cost will be substantially lower. This lower cost will enable pesticide applicators to have the instrument and realize spray droplet sizes before the applicators apply pesticide in the field. This knowledge will help applicators to create appropriate mitigation plans before the pesticide is applied.

Another intangible benefit of the illustrative systems would be that it would enable pesticide manufacturers to optimize their products to have relatively bigger droplet and more deposition on the intended target.

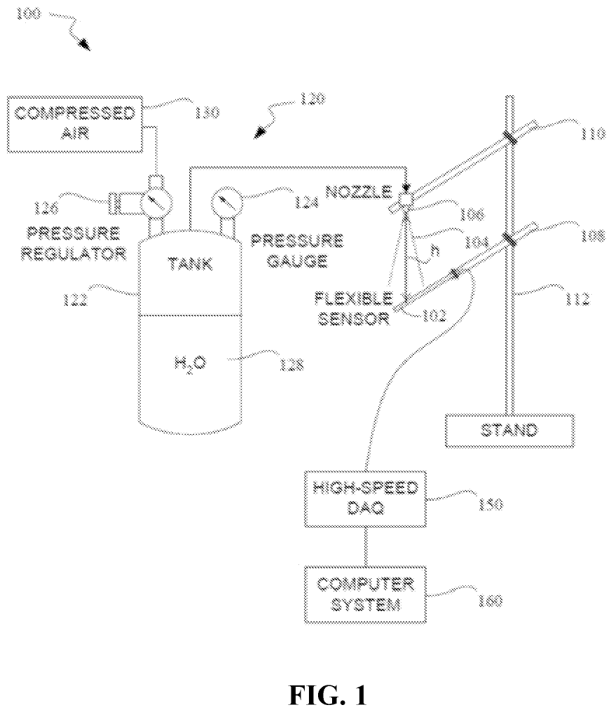

FIG. 1 depicts an exemplary system 100 for predicting one or more spray droplet size statistics, according to one or more embodiments. The system 100 includes vibration sensor, such as a flexible resistor 102, to sense vibration induced by impacts of spray droplets 104 on a substrate (i.e., the upper surface of the flexible resistor 102, in the illustrated embodiment), wherein the spray droplets 104 are emitted by a nozzle 106 positioned a predetermined distance h (e.g., 30.5 cm) from the substrate. In the illustrated embodiment, the flexible resistor 102 and the nozzle 106 are clamped to a lower beam 108 and an upper beam 110, respectively, each of which is clamped to a stand 112.

The predetermined distance h may be any suitable distance. Typically, the predetermined distance will vary depending on the particular application for which predicted spray droplet size statistics are desired. The predetermined distance used when predicting spray droplet size statistics must be consistent with the predetermined distance used when building the prediction model, as described below.

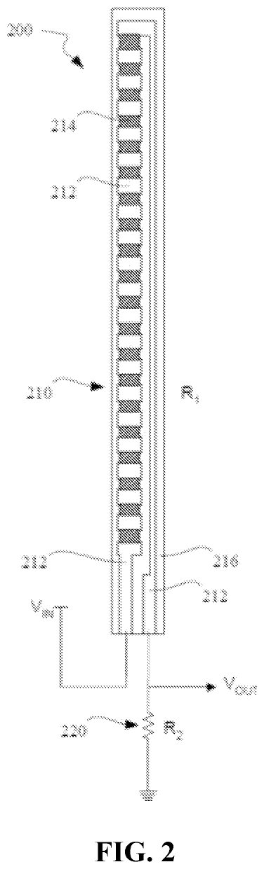

The flexible resistor 102 is electrically connected in series to a precision resistor (not shown in FIG. 1, 220 in FIG. 2) to form a voltage divider circuit (not shown in FIG. 1, 200 in FIG. 2). The flexible resistor 102 is conventional and commercially available. Flexible resistors are also referred to as “flexible sensors”, “flex sensors”, and “flexible potentiometers”. For example, exemplary suitable flexible resistors are available from SparkFun Electronics, Niwot, CO under the tradenames Flex Sensor 2.2″ SEN-10264 and Flex Sensor 4.5″ SEN-08606. Also, U.S. Pat. No. 5,583,476 discloses suitable flexible resistors.

The precision resistor (210 in FIG. 2) is conventional and commercially available. Examples of suitable precision resistors include, but are not limited to, metal film resistors, thin film resistors, metal foil resistors, film resistors, metal oxide resistors, thick film resistors, wire wound resistors, and other similar resistors. Preferably, the resistance of the precision resistor and the flat resistance of the flexible resistor 102 (i.e., the resistance of the flexible resistor 102 in the flat, unbent state) are about equal for purposes of forming an effective voltage divider circuit. For purposes of illustration, the flat resistance of the Flex Sensor 2.2″ SEN-10264 is 25,000 Ohms±30%.

As noted above, other vibration sensors may be used in lieu of, or in addition to, the flexible resistor 120. Suitable examples of such alternative vibration sensors include, but are not limited to, an accelerometer and a cantilevered beam with a stain gauge. Such accelerometers and strain gauges are conventional and commercially available.

A high-speed data acquisition device (DAQ) 150 is operatively connected to receive an output signal from the vibration sensor (e.g., flexible resistor 102 via the voltage divider circuit) to acquire vibration data in the time domain. The high-speed DAQ 150 is conventional and commercially available. For example, an exemplary high-speed DAQ is available from Measurement Computing Corp., Norton, MA under the tradename USB-204 Analog and Digital I/O). Preferably, the high-speed DAQ is capable of handling the typical vibration measurement conditions, i.e., up to about 2 s (e.g., 2 s) and up to about 1024 Hz (e.g., 1024 Hz).

As noted above, a microcontroller may be used to provide data acquisition in lieu of the high-speed DAQ 150. Such a microcontroller would be configured to provide, at the typical measurement conditions, analog-to-digital conversion of the analog voltage signal from the output of the voltage divider to digital vibration data. As noted above, the typical vibration measurement conditions are up to about 2 s (e.g., 2 s) and up to about 1024 Hz (e.g., 1024 Hz). Suitable microcontrollers are conventional and commercially available.

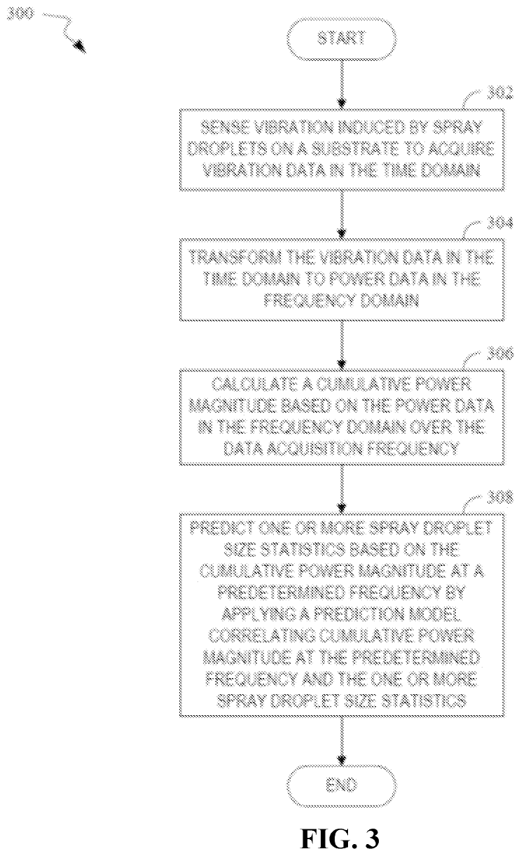

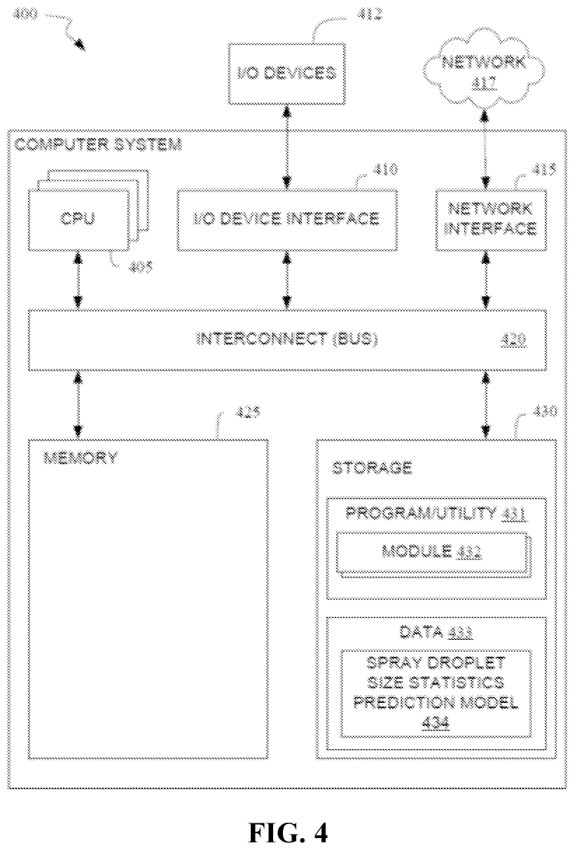

A computing device, such as a computer system 160, is operatively connected to the data acquisition device (DAQ) 150. The computer system 160 is conventional and commercially available. A representation of a suitable example of such a computer system is depicted in FIG. 4. As discussed below with reference to the illustrative method depicted in FIG. 3, the computing system 160 receives the vibration data in the time domain from the high-speed DAQ 150 and to performs a method comprising: transforming the vibration data in the time domain to power data in the frequency domain; calculating a cumulative power magnitude based on the power data in the frequency domain over the data acquisition frequency; and predicting one or more spray droplet size statistics based on the cumulative power magnitude at a predetermined frequency by applying a prediction model correlating cumulative power magnitude at the predetermined frequency and the one or more spray droplet size statistics.

A hydraulic system 120 includes a pressure tank 122 (e.g., stainless-steel pressure tank with a capacity of 18.9 L), a pressure gauge 124, a pressure regulator 126, and the above-mentioned nozzle 106 (e.g., a spray nozzle head with a twist cap). These components are connected to each other with tubing. Compressed air 130 is used to pressurize the tank 122, the pressure of which may be manually adjusted using the pressure regulator 126. The pressure gauge 124 displays the working pressure. In the illustrated example, the pressure tank 122 contains water 128. However, the pressure tank 122 may contain any liquid (e.g., a pesticide, herbicide, fertilizer, etc.) that is desired to be sprayed by the nozzle 106.

FIG. 2 depicts an exemplary voltage divider circuit 200 including a flexible resistor that may be utilized, according to one or more embodiments, within the system for predicting one or more spray droplet size statistics shown in FIG. 1. The voltage divider circuit 200 includes a flexible resistor 210 electrically connected in series with a precision resistor 220. The flexible resistor 210 has a resistance R₁ that changes depending upon the deflection or the bending of the substrate 216. The precision resistor 220 has a constant resistance R₂. The voltage divider circuit 200 has an input voltage V_{IN} connected to a first terminal of the flexible resistor 210, an output voltage V_{OUT} connected between a second terminal of the flexible resistor 210 and a first terminal of the precision resistor 220 (i.e., this V_{OUT} terminal between the two series-connected resistors 210,220 is also referred to herein as the “midpoint” of the voltage divider circuit), and a ground connected to a second terminal of the precision resistor 220.

$${V}_{OUT} = {V}_{IN} ( {R}_{1} / ( {R}_{1} + {R}_{2} ) ) .$$

The flexible resistor 210 in FIG. 2 corresponds with the flexible resistor 102 in FIG. 1. Typically, the flexible resistor includes a deflectable substrate 216 such as a phenolic resin on which is deposited a conductive ink 214 arranged in a pattern that bridges gaps in segmented conductor traces 212. The conductive ink 214 includes conductive particles that move further apart as the substrate 216 deflects or bends, thereby increasing the resistance of the flexible resistor 210 (as compared to the flat resistance). When the substrate straightens out again, the conductive particles move closer together again, thereby returning the resistance of the flexible resistor 210 to the original (flat) resistance.

FIG. 3 is a flow diagram of an illustrative method 300 of predicting one or more spray droplet size statistics, according to one or more embodiments. The method 300 sets forth the preferred order of the blocks. It must be understood, however, that the various blocks may occur at any time relative to one another.

The method 300 begins by sensing the vibration induced by spray droplets on a substrate to acquire vibration data in the time domain (block 302). For example, the vibration data may be acquired at a data acquisition frequency (e.g., up to about 1024 Hz) and over a measurement time (e.g., up to about 2 s) using a data acquisition system (DAQ) or a microcontroller. The vibration data may include a voltage signal output from a vibration sensor, such as a flexible resistor, an accelerometer, or a cantilever beam with a strain gauge. In some embodiments, the vibration sensor may include a flexible resistor connected in series with a precision resistor to form a voltage divider.

The method 300 continues by transforming the vibration data in the time domain to power data in the frequency domain (block 304). For example, the vibration data in the time domain may be transformed to power data in the frequency domain by applying the Fast Fourier transform (FFT) to the vibration data in the time domain.

The method 300 continues by calculating a cumulative power magnitude based on the power data in the frequency domain over the data acquisition frequency (block 306). For example, calculating a cumulative power magnitude based on the power data in the frequency domain over the data acquisition frequency may include calculating the cumulative power distribution over the data acquisition frequency, normalizing the cumulative power distribution by the total cumulated power, and expressing the normalized cumulative power distribution as a percentage of the total cumulated power.

The method 300 continues by predicting one or more spray droplet size statistics based on the cumulative power magnitude at a predetermined frequency (e.g., less than about 512 Hz) by applying a prediction model correlating cumulative power magnitude at the predetermined frequency and the one or more spray droplet size statistics (block 308). For example, the prediction model may be a linear regression model correlating cumulative power magnitude at the predetermined frequency and the one or more spray droplet size statistics (e.g., at least one of volumetric droplet diameters D_{V10}, D_{V50} and D_{V90}).

In some embodiments, the method 300 additionally includes building the prediction model correlating cumulative power magnitude at the predetermined frequency (e.g., preferable less than about 512 Hz) and the one or more spray droplet size statistics for each of a plurality of nozzles of different sizes. Typically, the predetermined frequency is selected based on the largest cumulative power magnitude differences between the plurality of nozzles.

FIG. 4 is a block diagram illustrating an exemplary representation of a computer system 400 for performing a computer-implemented method of predicting one or more spray droplet size statistics. As shown, the computer system 400 includes, without limitation, at least one CPU 405, a network interface 415, an interconnect 420, a memory 425, and storage 430. The computer system 400 may also include an I/O device interface 410 used to connect I/O devices 412 (e.g., keyboard, display, mouse devices, and data acquisition system (DAQ), such as DAQ 150 in FIG. 1) to the computer system 400.

Each CPU 405 retrieves and executes programming instructions stored in the memory 425 and storage 430. Similarly, the CPU 405 stores and retrieves application data residing in the memory 425 and storage 430. The network interface 415 is configured to transmit data via the communications network 417. The interconnect 420 is used to transmit programming instructions and application data between each CPU 405, I/O device interface 410, network interface 415, memory 425, and storage 430.

The interconnect 420 may be one or more busses. CPU 405 is included to be representative of a single CPU, multiple CPUs, a single CPU having multiple processing cores, and the like. Memory 425 is generally included to be representative of a random access memory, e.g., SRAM, DRAM or Flash. Storage 430, such as a hard disk drive, solid state disk (SSD), or flash memory storage drive, may store non-volatile data. Although shown as a single unit, the storage 430 may be a combination of fixed and/or removable storage devices, such as fixed disc drives, removable memory cards, optical storage, SSD or flash memory devices, network attached storage (NAS), connections to storage area-network (SAN) devices, or to the cloud.

A program/utility 431, having a set (at least one) of program modules 432, may be stored in storage 430 by way of example, and not limitation, as well as an operating system, one or more application programs, other program modules, and program data. Each of the operating system, one or more application programs, other program modules, and program data or some combination thereof, may include an implementation of a networking environment. The program modules 432 generally carry out the functions and/or methodologies of one or more embodiments as described herein. Storage 430 may also contain data 433, such as a spray droplet size statistics prediction model 434 (e.g., a mathematical equations or a look-up table that relates cumulative power magnitude at a predetermined frequency with respect to one or more spray droplet size statistics).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In one or more embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to one or more embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

One or more embodiments may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g., an amount of storage space used by a user or a number of virtualized systems instantiated by the user). A user can access any of the resources that reside in the cloud at any time, and from anywhere across the Internet. In context of the present invention, a user may access applications or related data available in the cloud. For example, the nodes used to create a stream computing application may be virtual machines hosted by a cloud service provider.

Doing so allows a user to access this information from any computing system attached to a network connected to the cloud (e.g., the Internet).

The following examples are intended only to further illustrate the invention and are not intended to limit the scope of the invention as defined by the claims.

### EXAMPLES

### Materials and Methods

### Device Design and Data Analysis

The device included of a flexible resistor (SEN-10264, SparkFun Electronics, Niwot, CO, USA) and a high precision resistor, and they were connected in series to form a voltage divider. A high-speed data acquisition system (DAQ) (USB-204, Measurement Computing Corp., Norton, MA, USA) was connected to a computer via a USB cable and supplied a 5 V DC to the divider, and the outputs of the divider were connected to the DAQ to acquire electrical signal on digit. A customized software was developed with Visual Basic. NET (Microsoft Corporation, Redmond, WA, USA) to set data acquisition parameters (acquisition time and frequency) and store acquired data in a text file.

The device was positioned at 30.5 cm under a spray nozzle (FIG. 1). A hydraulic system included of a stainless-steel pressure tank (capacity 18.9 L), pressure gauge and regulator, and spray nozzle head with a twist cap which connected each other with a tube. The building air was used to pressurize the tank, and the pressure regulator and gauge adjusted manually and displayed the working pressure, respectively.

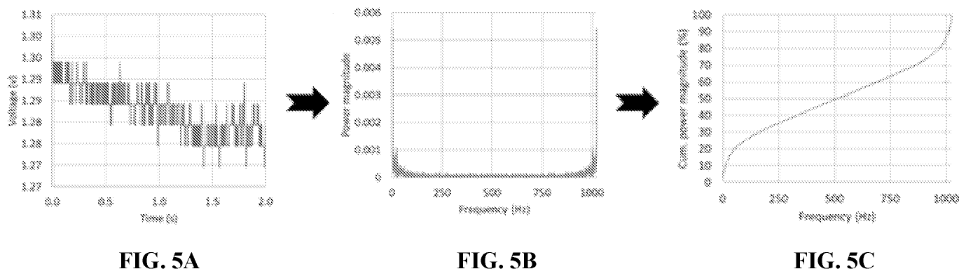

FIG. 5 is a flow diagram of illustrative data analysis steps that may be utilized for predicting spray droplet size statistics, according to one or more embodiments. In the left-section of FIG. 5, plot a) depicts vibration data output (i.e., voltage in the time domain). In the mid-section of FIG. 5, plot b) depicts data after application of the Fast Fourier transform (i.e., power magnitude in the frequency domain). In the right-section of FIG. 5, plot c) depicts normalized cumulative power in the frequency domain. The data obtained from each measurement, expressed as voltage in the time domain, were transformed into power in the frequency domain by means of the Fast Fourier Transformation using Microsoft Excel R 2016 (Microsoft Corporation, Redmond, WA, USA). Finally, the cumulative power distribution over data acquisition frequency was calculated and these data were normalized by the total cumulated value and expressed as a percentage of it.

### DAQ Parameters for Vibration Measurement

A measurement condition was identified by examining the influences of data acquisition times (0.5, 2.0, and 4.0 s) and sampling frequency (512, 1024 and 2048 Hz) in the power distributions. For this, a flat fan nozzle (XR8002, TeeJet Technologies LLC, Wheaton, IL, USA) was used working at 275.8 kPa. Repeatability was also considered by acquiring data over three different days with the best combination. The surface of the flexible resistor was wiped manually between measurements to avoid the influence of water deposition in vibration measurements.

### Spray Droplet Size Measurements

To correlate vibration data with droplet size statistics (D_{V10}, D_{V50} and D_{V90}), a Spraytec laser diffraction system (Malvern Panalytical Ltd., Malvern, UK) was used to measure droplet size statistics of all nozzles used at 275.8 kPa. The Spraytec was equipped with a lens with a focal length of 750 mm suitable for measuring particle sizes from 2 μm to 2000 μm. The distance between the transmitter and receiver modules was fixed at 99 cm. The nozzles were set centered at a height of 30.5 cm above the measurement area, in the middle of the two modules. The optical bench between the modules was covered with a meshed filter sheet to prevent the rebound of the droplets. Spraytec software v3.30 (Malvern Panalytical Ltd., Malvern, UK) was used to acquire and visualize data every second. The standard operational procedure set at the software took into account the materials being analyzed (water particles dispersed in the air), the lens, and the sampling time (15 s). The background light adjustment and the alignment of the modules' optics were automatically conducted prior to each measurement. Each measurement started once the obscuration was stabilized in 0.0%. For each combination of nozzles and working pressures, three measurements were made and used as replicates.

### Prediction Model and Validation

To build the model for predicting the droplet size statistics, the vibration from following the standard condition spraying with nine different flat fan nozzles (XR11001, XR11002, XR11004, XR11006, XR11008, XR8002, XR8004, XR8006, and XR8008) was measured at the working pressure of 275.8 kPa. To validate the model, the vibration was also measured following the same methodology and working pressure in eight separate flat fan nozzles (XR11002, XR11003, XR11005, XR11006, XR8002, XR8003, XR8005, and XR8006).

Correlation between normalized cumulative power magnitude and droplet size statistics were calculated using JMPR Pro v.15 (SAS Institute Inc., Cary, NC, USA). For the model validation, the approximation errors between measured and predicted droplet size statistics were calculated using equation (1).

$$Absolute approximation error ( \% ) = \frac{\vert Measured size - predicted size \vert}{Measured size} * 100 \qquad ( 1 )$$

### Results and Discussion

### DAQ Parameters for Vibration Measurement

When comparing the power spectra from data acquired at 512, 1024 and 2048 Hz, 1024 Hz produced less variation among repetitions. Power data from vibration data collected for 0.5 s and 2 s at 1024 Hz sampling rate had 22% and 2.2% of variations, respectively, compared to power data from the data collected for 4 s at the same sampling rate. According to these initial results, the DAQ parameters of acquisition time and frequency were standardized to 2 s at 1024 Hz, respectively, when spray droplet vibration data was collected. The power spectra data from the vibration data acquired repeatedly over three days under standardized parameters showed the variation less than 5%.

### Prediction Model

Measured droplet size statistics showed high repeatability, as the standard deviation of Dvio of the three replicates was found to be less than 3 μm. As expected, the droplet sizes increased as the orifice size of nozzles increased at the same working pressure.

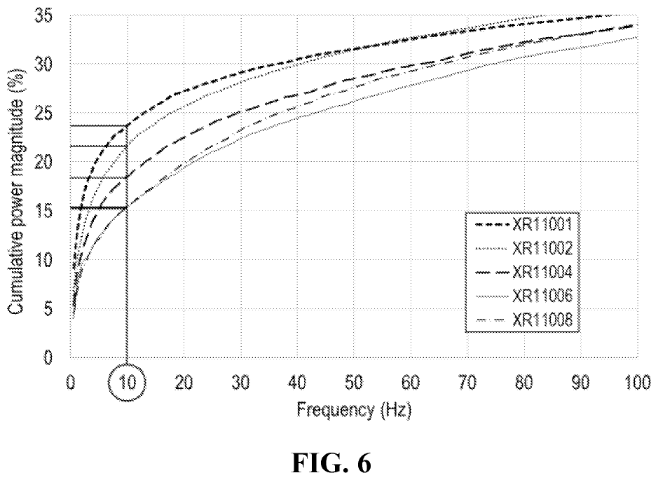

FIG. 6 depicts a plot of cumulative power magnitude in the frequency domain which may be utilized in frequency selection (e.g., 10 Hz in this illustrative example) for the prediction model, according to one or more embodiments. As shown in FIG. 6, the cumulative power of the vibration produced by spray droplets from the different nozzles over the device. Our results showed that nozzles with smaller orifice sizes had more power than ones with the bigger orifices at lower frequency range. Therefore, to build the prediction models, the cumulative power at a frequency of 10 Hz were used, since they corresponded to the largest cumulative power magnitude differences between nozzles.

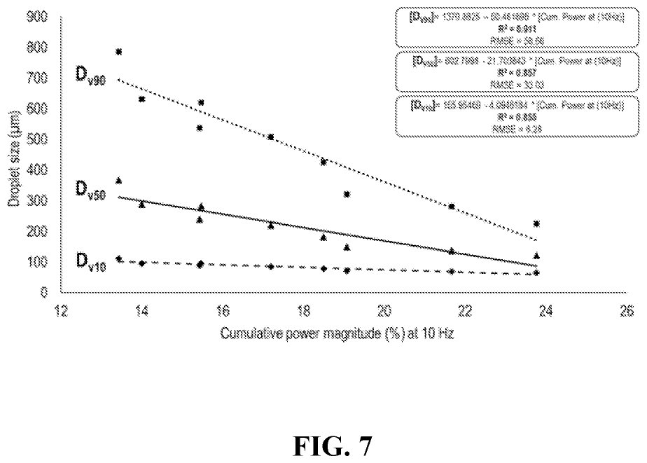

FIG. 7 depicts a plot of droplet size in relation to cumulative power magnitude from spray vibration at the selected frequency (e.g., 10 Hz in this illustrative example) of volumetric droplet diameters D_{V10} (denoted by squares), D_{V50} (denoted by triangles), and D_{V90} (denoted by rhombuses), according to one or more embodiments. In FIG. 7, lines represent the linear regressions for the respective volume droplet diameters. Also in FIG. 7, illustrative prediction models (i.e., mathematical equations corresponding to the linear regressions for the respective volume droplet diameters) are shown, along with the coefficient of determination (R²) and the root mean square error (RSME). As shown in FIG. 7, the coefficients of determination (R²) of the models were over 0.85.

### Model Validation

The three linear regression models were used to predict the droplet size statistics of the validation nozzles. Table 1 shows the absolute approximation errors of the models in predicting droplet size statistics. The D_{V10} and D_{V90} models had approximation errors from 0.1-8.0% (0.08-9.38 μm) and 1.4-16.9% (7.00-74.82 μm). Absolute approximation errors of 1.3-8.6% (2.35-23.39 μm) were observed from the D_{V50} prediction model.

TABLE 1
Vibration response (cumulative power magnitude at 10 Hz) to predict droplet size statistics with
linear regressions in FIG. 4, actual droplet size measured with laser diffraction system, and
absolute approximation error (Approx. Error) for the different nozzles used in the validation.

| | | D_{V10} | | | D_{V50} | | | D_{V90} | | |
|---|---|---|---|---|---|---|---|---|---|---|
| | | | | Absolute | | | Absolute | | | Absolute |
| | | Actual | Predicted | Approx. | Actual | Predicted | Approx. | Actual | Predicted | Approx. |
| | Vibration | size | size | Error | size | size | Error | size | size | Error |
| Nozzle | response | (μm) | (μm) | (%) | (μm) | (μm) | (%) | (μm) | (μm) | (%) |
| XR11003 | 20.68 | 75.42 | 71.29 | 5.5% | 163.13 | 154.05 | 5.6% | 390.02 | 327.01 | 16.2% |
| XR11005 | 17.22 | 85.00 | 85.46 | 0.5% | 217.04 | 229.13 | 5.6% | 508.57 | 501.57 | 1.4% |
| XR8003 | 19.85 | 79.71 | 74.69 | 6.3% | 184.68 | 172.05 | 6.8% | 443.68 | 368.87 | 16.9% |
| XR8005 | 15.20 | 92.82 | 93.72 | 1.0% | 260.57 | 272.91 | 4.7% | 582.05 | 603.36 | 3.7% |
| XR11002 | 20.93 | 70.33 | 70.25 | 0.1% | 143.49 | 148.52 | 3.5% | 331.18 | 314.15 | 5.1% |
| XR8002 | 19.36 | 81.09 | 76.70 | 5.4% | 185.04 | 182.69 | 1.3% | 416.03 | 393.60 | 5.4% |
| XR11006 | 16.29 | 95.83 | 89.27 | 6.8% | 272.73 | 249.34 | 8.6% | 589.55 | 548.57 | 7.0% |
| XR8006 | 11.81 | 116.96 | 107.58 | 8.0% | 362.38 | 346.37 | 4.4% | 742.00 | 774.16 | 4.3% |

The averages of the absolute approximation errors were generally less than 10% of the measured spray droplet size statistics except while predicting D_{V90}. The highest errors were expected D_{V90} predictions since this model had the largest RMSE (FIG. 7). This result would agree with what was concluded by Sijs et al., ibid (2021) that deviations between different measurement methods become larger with coarser droplets.

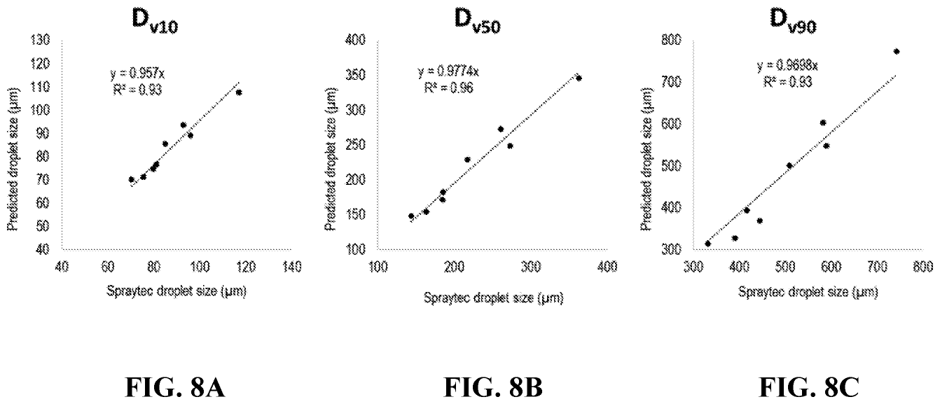

FIGS. 8A, 8B, and 8C depict illustrative validation curves for predicted droplet sizes that were predicted using prediction models for volumetric droplet diameters D_{V10}, D_{V50}, and D_{V90}, respectively, according to one or more embodiments. FIG. 8A depicts a plot of predicted droplet size in relation to measured droplet size for volume droplet diameter D_{V10}. FIG. 8B depicts a plot of predicted droplet size in relation to measured droplet size for volume droplet diameter D_{V50}. FIG. 8C depicts a plot of predicted droplet size in relation to measured droplet size for volume droplet diameter D_{V90}.

While this invention may be embodied in many different forms, there are described in detail herein specific preferred embodiments of the invention. The present disclosure is an exemplification of the principles of the invention and is not intended to limit the invention to the particular embodiments illustrated. All patents, patent applications, scientific papers, and any other referenced materials mentioned herein are incorporated by reference in their entirety. Furthermore, the invention encompasses any possible combination of some or all of the various embodiments and characteristics described herein and/or incorporated herein. In addition, the invention encompasses any possible combination that also specifically excludes any one or some of the various embodiments and characteristics described herein and/or incorporated herein.

The amounts, percentages and ranges disclosed herein are not meant to be limiting, and increments between the recited amounts, percentages and ranges are specifically envisioned as part of the invention. All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10 including all integer values and decimal values; that is, all subranges beginning with a minimum value of 1 or more, (e.g., 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range.

Unless otherwise indicated, all numbers expressing quantities of ingredients, properties such as molecular weight, reaction conditions (e.g., reaction time, temperature), percentages and so forth as used in the specification and claims are to be understood as being modified in all instances by the term “about.” Accordingly, unless otherwise indicated, the numerical properties set forth in the following specification and claims are approximations that may vary depending on the desired properties sought to be obtained in embodiments of the present invention. As used herein, the term “about” refers to a quantity, level, value, or amount that varies by as much as 10% to a reference quantity, level, value, or amount. For example, about 1.0 g means 0.9 g to 1.1 g and all values within that range, whether specifically stated or not.

### Conclusion

A new device was developed to predict spray droplet size statistics from vibration data from spray droplets. The preliminary data from the device indicated that there was strong correlation with the coefficients of determination greater than 0.85 between vibration power and spray droplet size statistics.

Compared to the current techniques to determine spray droplet sizes, the simple device and analysis technique presented herein would be more affordable, and it could be used to collect droplet size data both in laboratory and field environments. Finally, further research work is needed to evaluate the device under different working pressure.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

All of the references cited herein, including U.S. Patents and U.S. Patent Application Publications, are incorporated by reference in their entirety. Also incorporated by reference in their entirety are the following references: U.S. Pat. Nos. 5,583,476 and 7,278,294.

Thus, in view of the above, there is described (in part) the following:

A method of predicting one or more spray droplet size statistics, comprising: sensing vibration induced by impacts of spray droplets on a substrate to acquire vibration data in the time domain, wherein the spray droplets are emitted by a nozzle positioned a predetermined distance from the substrate; transforming the vibration data in the time domain to power data in the frequency domain; calculating a cumulative power magnitude based on the power data in the frequency domain over the data acquisition frequency; and predicting one or more spray droplet size statistics based on the cumulative power magnitude at a predetermined frequency by applying a prediction model correlating cumulative power magnitude at the predetermined frequency and the one or more spray droplet size statistics.

A system of predicting one or more spray droplet size statistics, comprising: a vibration sensor to sense vibration induced by impacts of spray droplets on a substrate, wherein the spray droplets are emitted by a nozzle positioned a predetermined distance from the substrate; a data acquisition device and/or microcontroller operatively connected to receive an output signal from the vibration sensor to acquire vibration data in the time domain; and a computing device operatively connected to the data acquisition device to receive the vibration data in the time domain and to perform a method comprising transforming the vibration data in the time domain to power data in the frequency domain, calculating a cumulative power magnitude based on the power data in the frequency domain over the data acquisition frequency, and predicting one or more spray droplet size statistics based on the cumulative power magnitude at a predetermined frequency by applying a prediction model correlating cumulative power magnitude at the predetermined frequency and the one or more spray droplet size statistics.

A computer program product for predicting one or more spray droplet size statistics, the computer program product comprising a computer readable storage medium having program code embodied therewith, the program code executable by one or more processors, to perform a method comprising: sensing vibration induced by impacts of spray droplets on a substrate to acquire vibration data in the time domain, wherein the spray droplets are emitted by a nozzle positioned a predetermined distance from the substrate; transforming the vibration data in the time domain to power data in the frequency domain; calculating a cumulative power magnitude based on the power data in the frequency domain over the data acquisition frequency; and predicting one or more spray droplet size statistics based on the cumulative power magnitude at a predetermined frequency by applying a prediction model correlating cumulative power magnitude at the predetermined frequency and the one or more spray droplet size statistics.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

What is claimed is:

1. A method of predicting one or more spray droplet size statistics, comprising:
sensing vibration induced by impacts of spray droplets on a substrate to acquire vibration data in the time domain, wherein the spray droplets are emitted by a nozzle positioned a predetermined distance from the substrate;
transforming the vibration data in the time domain to power data in the frequency domain;
calculating a cumulative power magnitude based on the power data in the frequency domain over the data acquisition frequency;
predicting one or more spray droplet size statistics based on the cumulative power magnitude at a predetermined frequency by applying a prediction model correlating cumulative power magnitude at the predetermined frequency and the one or more spray droplet size statistics.

2. The method of claim 1, wherein the vibration data is acquired at the data acquisition frequency and over a measurement time using a data acquisition device and/or microcontroller.

3. The method of claim 2, wherein the data acquisition frequency is up to about 1024 Hz and the measurement time is up to about 2 s.

4. The method of claim 1, wherein the vibration data includes a voltage signal output from a vibration sensor, and wherein the vibration sensor includes at least one of a flexible resistor, an accelerometer, and a cantilever beam with a strain gauge.

5. The method of claim 4, wherein the vibration sensor includes a flexible resistor connected in series with a precision resistor to form a voltage divider.

6. The method of claim 1, wherein transforming the vibration data in the time domain to power data in the frequency domain includes applying the Fast Fourier transform (FFT) to the vibration data in the time domain.

7. The method of claim 1, wherein calculating a cumulative power magnitude based on the power data in the frequency domain over the data acquisition frequency includes calculating the cumulative power distribution over the data acquisition frequency, normalizing the cumulative power distribution by the total cumulated power, and expressing the normalized cumulative power distribution as a percentage of the total cumulated power.

8. The method of claim 1, wherein the prediction model is a linear regression model correlating cumulative power magnitude at the predetermined frequency and the one or more spray droplet size statistics, and wherein the one or more spray droplet size statistics include at least one of volumetric droplet diameters D_{V10}, D_{V50} and D_{V90}.

9. The method of claim 1, further comprising:
building the prediction model correlating cumulative power magnitude at the predetermined frequency and the one or more spray droplet size statistics for each of a plurality of nozzles of different sizes, and wherein the predetermined frequency is selected based on the largest cumulative power magnitude differences between the plurality of nozzles.

10. The method of claim 8, wherein the predetermined frequency is less than about 512 Hz.

11. The method of claim 9, wherein the predetermined frequency is less than about 512 Hz.

12. A system of predicting one or more spray droplet size statistics, comprising:
a vibration sensor to sense vibration induced by impacts of spray droplets on a substrate, wherein the spray droplets are emitted by a nozzle positioned a predetermined distance from the substrate;
a data acquisition device and/or microcontroller operatively connected to receive an output signal from the vibration sensor to acquire vibration data in the time domain;
a computing device operatively connected to the data acquisition device to receive the vibration data in the time domain and to perform a method comprising
transforming the vibration data in the time domain to power data in the frequency domain,
calculating a cumulative power magnitude based on the power data in the frequency domain over the data acquisition frequency,
predicting one or more spray droplet size statistics based on the cumulative power magnitude at a predetermined frequency by applying a prediction model correlating cumulative power magnitude at the predetermined frequency and the one or more spray droplet size statistics.

13. The system of claim 12, wherein the vibration data is acquired at the data acquisition frequency and over a measurement time using a data acquisition device and/or microcontroller.

14. The system of claim 13, wherein the data acquisition frequency is up to about 1024 Hz and the measurement time is up to about 2 s.

15. The system of claim 12, wherein the vibration data includes a voltage signal output from a vibration sensor, and wherein the vibration sensor includes at least one of a flexible resistor, an accelerometer, and a cantilever beam with a strain gauge.

16. The system of claim 15, wherein the vibration sensor includes a flexible resistor connected in series with a precision resistor to form a voltage divider.

17. The system of claim 12, wherein transforming the vibration data in the time domain to power data in the frequency domain includes applying the Fast Fourier transform (FFT) to the vibration data in the time domain.

18. The system of claim 12, wherein calculating a cumulative power magnitude based on the power data in the frequency domain over the data acquisition frequency includes calculating the cumulative power distribution over the data acquisition frequency, normalizing the cumulative power distribution by the total cumulated power, and expressing the normalized cumulative power distribution as a percentage of the total cumulated power.

19. The system of claim 12, wherein the prediction model is a linear regression model correlating cumulative power magnitude at the predetermined frequency and the one or more spray droplet size statistics, and wherein the one or more spray droplet size statistics include at least one of volumetric droplet diameters D_{V10}, D_{V50} and D_{V90}.

20. The system of claim 12, wherein the predetermined frequency is less than about 512 Hz.

21. A computer program product for predicting one or more spray droplet size statistics, the computer program product comprising a computer readable storage medium having program code embodied therewith, the program code executable by one or more processors, to perform a method comprising:
sensing vibration induced by impacts of spray droplets on a substrate to acquire vibration data in the time domain, wherein the spray droplets are emitted by a nozzle positioned a predetermined distance from the substrate;
transforming the vibration data in the time domain to power data in the frequency domain;
calculating a cumulative power magnitude based on the power data in the frequency domain over the data acquisition frequency;
predicting one or more spray droplet size statistics based on the cumulative power magnitude at a predetermined frequency by applying a prediction model correlating cumulative power magnitude at the predetermined frequency and the one or more spray droplet size statistics.
